(19) United States
(12) Patent Application Publication
(10) Pub. No.: US 2024/0166781 A1
(43) Pub. Date: May 23, 2024

(54) MODIFIED DICYCLOPENTADIENE-BASED RESIN AND PREPARATION METHOD THEREOF

(71) Applicant: NAN YA PLASTICS CORPORATION, TAIPEI (TW)

(72) Inventors: Te-Chao Liao, TAIPEI (TW); Yu-Ting Liu, TAIPEI (TW); Hung-Yi Chang, TAIPEI (TW)

(73) Assignee: NAN YA PLASTICS CORPORATION, TAIPEI (TW)

(21) Appl. No.: 18/082,601

(22) Filed: Dec. 16, 2022

(30) Foreign Application Priority Data
Nov. 3, 2022 (TW) 111141995

(51) Int. Cl. C08F 132/08

(52) U.S. Cl. CPC C08F 132/08

(57) ABSTRACT

A modified dicyclopentadiene-based resin and a preparation method thereof are provided. The preparation method of the modified dicyclopentadiene-based resin includes sequentially performing nitration reaction and hydrogenation reaction of a dicyclopentadiene phenolic resin to form a modified dicyclopentadiene-based resin for which the structure has at least two amino groups. The hydrogenation reaction is performed in a solvent at a temperature of 50° C. to 120° C.

### CROSS-REFERENCE TO RELATED APPLICATION

This application claims the priority benefit of Taiwan application serial no. 111141995, filed on Nov. 3, 2022. The entirety of the above-mentioned patent application is hereby incorporated by reference herein and made a part of this specification.

### BACKGROUND

### Technical Field

The invention relates to a dicyclopentadiene (DCPD)-based resin, particularly to a modified dicyclopentadiene-based resin and a preparation method thereof for which the structure includes an amino group.

### Description of Related Art

The currently widely used hardener is an epoxy resin hardener with amine groups, which has good reactivity and reliability. However, currently used amine-based epoxy resin hardeners have poor dielectric properties, which limits their application to insulating materials for electronic substrates.

### SUMMARY

The invention provides a modified dicyclopentadiene-based resin and a preparation method thereof capable of providing good dielectric properties and heat resistance.

A preparation method of a modified dicyclopentadiene-based resin of the invention is formed by performing nitration reaction and hydrogenation reaction of a dicyclopentadiene phenolic resin in sequence to form a modified dicyclopentadiene-based resin for which the structure has at least two amino groups. The hydrogenation reaction is performed in a solvent at a temperature of 50° C. to 120° C.

In an embodiment of the invention, the solvent includes tetrahydrofuran, toluene, isopropanol, dimethylacetamide, or a combination thereof.

In an embodiment of the invention, the hydrogenation reaction is performed at a pressure of 5 bar to 100 bar for 4 hours to 12 hours.

In an embodiment of the invention, the preparation method further includes adding a catalyst to perform the hydrogenation reaction. Based on a total usage amount of 100 parts by weight of a reactant, a usage amount of the catalyst is 0.5 parts by weight to 2 parts by weight.

A modified dicyclopentadiene-based resin of the invention is prepared by the preparation method of a modified dicyclopentadiene-based resin above.

In an embodiment of the invention, a weight average molecular weight of the modified dicyclopentadiene-based resin is 800 to 4,000, and a number average molecular weight of the modified dicyclopentadiene-based resin is 400 to 2,000.

In an embodiment of the invention, a polydispersity index of the modified dicyclopentadiene-based resin is 1.2 to 2.

A modified dicyclopentadiene-based resin of the invention has a structure represented by Formula (1) as follows:

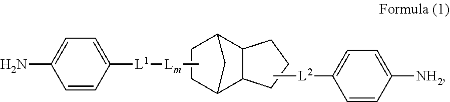

in Formula (1), L represents a dicyclopentadienylene group, a divalent organic group derived from a phenol-based compound or a combination thereof,
L¹ and L² each represent a divalent organic group derived from a phenol-based compound, and,
m represents an integer from 0 to 10.

In an embodiment of the invention, the phenol-based compound includes phenol.

In an embodiment of the invention, the L represents

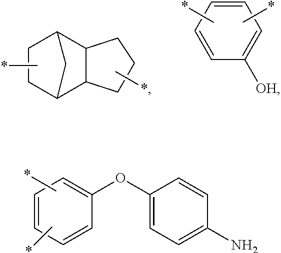

or a combination thereof, and * represents a bonding position.

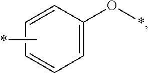

In an embodiment of the invention, the L¹ and L² each represent and * represents a bonding position.

Based on the above, the invention provides a preparation method of a dicyclopentadiene-based resin to form a dicyclopentadiene-based resin for which the structure has at least two amino groups, which has good dielectric properties and heat resistance. Thus, it is suitable as a hardener or for forming a dicyclopentadiene-based resin with other reactive groups.

To make the features and advantages of the disclosure to be comprehended more easily, embodiments are described in detail as follows.

### DESCRIPTION OF THE EMBODIMENTS

The following are embodiments describing the content of the invention in detail. The implementation details provided in the embodiments are for illustrative purposes, and are not intended to limit the scope of protection of the content of the invention. Those with ordinary knowledge in the art may modify or change these implementation details according to the needs of the actual implementation.

The “divalent organic group” as used in the specification is an organic group having two bonding positions. And the “divalent organic group” may form two chemical bonds through these two bonding positions.

### <Preparation Method of Modified Dicyclopentadiene-Based Resin>

A preparation method of a dicyclopentadiene-based resin of the embodiment includes performing nitration reaction and hydrogenation reaction of a dicyclopentadiene phenolic resin in sequence to form a modified dicyclopentadiene-based resin for which the structure has at least two amino groups.

Specific examples of commercially available products of dicyclopentadiene phenolic resin may include ERM6105 (trade name; manufactured by Songwon Industrial Co., Ltd.; weight average molecular weight: 800), ERM6115 (trade name; manufactured by Songwon Industrial Co., Ltd.; weight average molecular weight: 1,100), ERM6140 (trade name; manufactured by Songwon Industrial Co., Ltd.; weight average molecular weight: 1,300) or other suitable dicyclopentadiene phenolic resins. A weight average molecular weight of the dicyclopentadiene phenolic resin is 400 to 2,000, preferably 800 to 2,000.

The method of nitration reaction is not particularly limited, for example, well-known nitration reaction may be performed. For example, the nitration reaction may be performed by adding 4-halonitrobenzene to a solution which has dissolved a dicyclopentadiene phenolic resin. 4-halonitrobenzene includes 4-fluoronitrobenzene, 4-chloronitrobenzene, 4-bromonitrobenzene or 4-iodonitrobenzene, preferably 4-fluoronitrobenzene. A ratio of a mole number of the dicyclopentadiene phenolic resin and a mole number of the 4 halonitrobenzene may be 1:1 to 1:2.5, preferably 1:1.01 to 1:1.05. The solvent dissolved the dicyclopentadiene phenolic resin is not particularly limited, and suitable solvent may be selected according to needs. For example, the solvent dissolved the dicyclopentadiene phenolic resin may include dimethylacetamide, toluene, butanone or other suitable solvents, preferably dimethylacetamide.

The hydrogenation reaction is performed in a solvent at a temperature of 50° C. to 120° C., preferably 50° C. to 90° C. In this embodiment, the hydrogenation reaction may be performed in a solvent of tetrahydrofuran, toluene, isopropanol, dimethylacetamide, or a combination thereof, preferably dimethylacetamide. For example, in a mixed solvent of toluene and isopropanol, a volume ratio of toluene to isopropanol may be 80:20 to 100:0, preferably 80:20 to 75:25; in a mixed solvent of dimethylacetamide and toluene, a volume ratio of dimethylacetamide to toluene may be 75:25 to 100:0, preferably 90:10 to 100:0. Thereby, the hydrogenation reaction may achieve a good hydrogenation rate, for example, which may be 90% or more, preferably 94% or more, more preferably 98% or more). In this embodiment, the hydrogenation reaction may be performed at a pressure of 5 bar to 100 bar for 4 hours to 12 hours, preferably at a pressure of 15 bar to 50 bar for 8 hours to 12 hours.

In this embodiment, the preparation method of a modified dicyclopentadiene-based resin further includes adding a catalyst to perform the hydrogenation reaction. The catalyst may include Pd/C catalyst or other suitable catalysts. Based on a total usage amount of 100 parts by weight of a reactant, a usage amount of the catalyst is 0.5 parts by weight to 2 parts by weight, preferably 1.35 parts by weight to 2 parts by weight.

Based on the preparation method above, the modified dicyclopentadiene-based resin of this embodiment may be prepared.

### <Modified Dicyclopentadiene-Based Resin>

A modified dicyclopentadiene-based resin of this embodiment is prepared by the preparation method of a modified dicyclopentadiene-based resin above. A structure of the modified dicyclopentadiene-based resin has at least two amino groups, preferably at least three amino groups. For example, the amino group may bond on a terminal (e.g. a terminal on both sides) and/or a branch of the modified dicyclopentadiene-based resin, preferably bond on a terminal on both sides and the branch of the resin. Thus, the modified dicyclopentadiene-based resin has good molecular weight distribution uniformity, heat resistance, peel resistance and dielectric properties.

The modified dicyclopentadiene-based resin has a structure represented by Formula (1) as follows. In this embodiment, a weight average molecular weight (Mw) of the modified dicyclopentadiene-based resin is 800 to 4,000, preferably 1,000 to 4,000; a number average molecular weight (Mn) thereof is 400 to 20,000, preferably 800 to 2,000; a polydispersity index (PDI) thereof is 1.2 to 2, preferably 1.2 to 1.5.

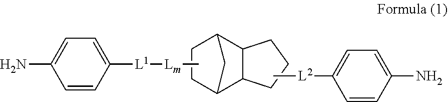

In Formula (1), L represents a dicyclopentadienylene group, a divalent organic group derived from a phenol-based compound or a combination thereof, preferably a combination of the dicyclopentadienylene group and the divalent organic group derived from the phenol-based compound, and the divalent group is preferably a divalent organic group including an amino group;
L¹ and L² each represent a divalent organic group derived from a phenol-based compound; and
m represents an integer from 0 to 10.

In this embodiment, the phenol-based compound may include phenol. L, L¹ and L² may represent a divalent group derived from phenol. In this embodiment, L may represent

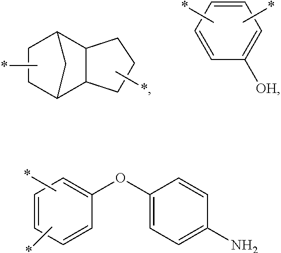

or a combination thereof, preferably a combination of

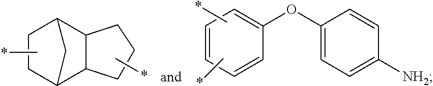

* represents a bonding position. L¹ and L² may each represent

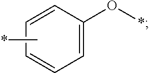

* represents a bonding position.

In this embodiment, the modified dicyclopentadiene-based resin has a structure represented by Formula (2) as follows.

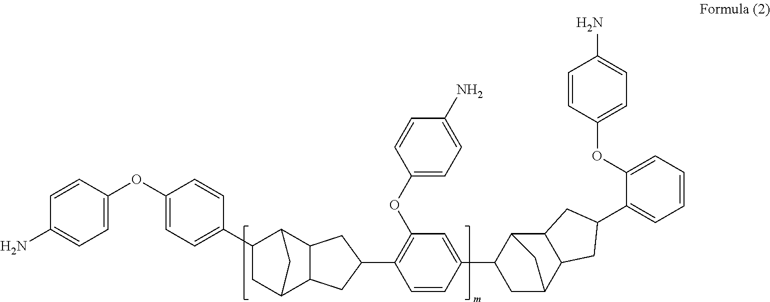

In Formula (2), m represents an integer from 0 to 10.

### Examples of Modified Dicyclopentadiene-Based Resin

Example 1 to Example 3 of the modified dicyclopentadiene-based resin are described below:

### Example 1

Dicyclopentadiene phenolic resin including 1 mole hydroxyl group (trade name: ERM6140, manufactured by Songwon Industrial Co., Ltd.; weight average molecular weight: 1,300) was added in 6 mole of dimethylacetamide (DMAC) to dissolve therein. Next, 1.25 mole of potassium carbonate and 1.25 mole of 4-fluoronitrobenzene were added thereto, and reacted at a temperature of 120° C. for 5 hours, and then cooled to room temperature. Then, filtration was performed to remove solids, followed by precipitation with a mixed solution of methanol and water to obtain a precipitate of nitrated dicyclopentadiene phenolic resin (DCPD-NO₂). Next, the precipitate was added to a mixed solvent of toluene and isopropanol (volume ratio: 80:20), and 1.2 parts by weight of Pd/C catalyst was added thereto, and reacted at a temperature of 110° C. and a pressure of 5 bar for 8 hours to perform a hydrogenation reaction and obtain a modified dicyclopentadiene-based resin for which the structure has amino groups bonded on the terminal of both sides and the branch (DCPD-NH₂), and may have a structure represented by Formula (2) (m representing an integer from 0 to 10). The obtained modified dicyclopentadiene-based resin was evaluated by each of the following evaluation methods, and the results thereof are as shown in Table 1.

### Example 2 to Example 3

The modified dicyclopentadiene-based resin of Example 2 to Example 3 were prepared using the same steps as Example 1, and the difference thereof is: the solvent, reaction time, reaction temperature and/or reaction pressure used in the hydrogenation reaction were changed (as shown in Table 1). The obtained modified dicyclopentadiene-based resin were evaluated by each of the following evaluation methods, and the results thereof are as shown in Table 1.

TABLE 1

| | Item | Example 1 | Example 2 | Example 3 |
|---|---|---|---|---|
| Hydro- | Solvent | Toluene:Iso- | DMAC:Tol- | DMAC |
| genation | | propanol = | uene = 80:20 | |
| conditions | | 80:20 | (volume ratio) | |
| | | (volume ratio) | | |
| | Usage amount | 1.2 | 1.2 | 1.2 |
| | of catalyst | | | |
| | (parts by | | | |
| | weight) | | | |
| | Reaction time | 8 | 10 | 10 |
| | (hour) | | | |
| | Reaction | 110 | 90 | 90 |
| | temperature | | | |
| | (° C.) | | | |
| | Reaction | 5 | 20 | 20 |
| | pressure (bar) | | | |
| Hydrogenation rate (%) | | 94 | 96 | 99 |
| Evaluation | Mn (g/mol) | 2457 | 1245 | 989 |
| results | Mw (g/mol) | 7444 | 2029 | 1483 |
| | PDI | 3.03 | 1.63 | 1.50 |
| | Solubility in | 30 | 50 | 50 |
| | toluene (%) | | | |
| | Solubility in | 30 | 50 | 50 |
| | butanone (%) | | | |
| | Dielectric | 3.6 | 3.5 | 3.4 |
| | constant | | | |
| | Dissipation | 0.0045 | 0.0042 | 0.0038 |
| | factor | | | |
| | Tg (° C.) | 224 | 252 | 265 |
| | Peel strength | 3.1 | 3.4 | 3.8 |
| | (lb/in) | | | |

### <Evaluation Methods>

a. Number Average Molecular Weight (Mn)

The prepared modified dicyclopentadiene-based resin was dissolved in tetrahydrofuran (THF) to prepare a solution to be tested with a concentration of 1% by weight (wt %). Next, the solution to be tested was measured for a number average molecular weight via gel permeation chromatography (GPC).

b. Weight Average Molecular Weight (Mw)

The prepared modified dicyclopentadiene-based resin was dissolved in tetrahydrofuran (THF) to prepare a solution to be tested with a concentration of 1% by weight (wt %). Next, the solution to be tested was measured for a weight average molecular weight via gel permeation chromatography (GPC).

c. Polydispersity Index (PDI)

The measured weight average molecular weight is divided by the measured number average molecular weight (i.e. Mw/Mn) to obtain a polydispersity index (PDI). When the polydispersity index is smaller, the distribution of molecular weight of the modified dicyclopentadiene-based resin is more uniform.

d. Solubility in Toluene

1 g of the prepared modified dicyclopentadiene-based resin was placed in a container, and then toluene was added thereto to make a solution weighing 2 g. The solution was left to stand for about 30 minutes after shaking at room temperature. After it was a clear solution, its solubility was measured.

e. Solubility in Butanone

1 g of the prepared modified dicyclopentadiene-based resin was placed in a container, and then butanone was added thereto to make a solution weighing 2 g. The solution was left to stand for about 30 minutes after shaking at room temperature. After it was a clear solution, its solubility was measured.

f. Dielectric Constant (Dk)

The prepared modified dicyclopentadiene-based resin was coated on a substrate, and baked at a temperature of 120° C. for 2 minutes, and then hot pressed at a temperature of 210° C. for 3 hours to form a film with thickness of 100 μm. Next, the film was measured for a dielectric constant (Dk) at a frequency of 10 GHz via a dielectric analyzer (model: E4991A; manufactured by Agilent Technologies, Inc.). When the dielectric constant is smaller, the modified dicyclopentadiene-based resin has good dielectric property.

g. Dissipation Factor (Df)

The prepared modified dicyclopentadiene-based resin was coated on a substrate, and baked at a temperature of 120° C. for 2 minutes, and then hot pressed at a temperature of 210° C. for 3 hours to form a film with thickness of 100 μm. Next, the film was measured for a dissipation factor (DO at a frequency of 10 GHz via a dielectric analyzer (model: E4991A; manufactured by Agilent Technologies, Inc.). When the dissipation factor is smaller, the modified dicyclopentadiene-based resin has good dielectric property.

h. Glass Transition Temperature (Tg)

The prepared modified dicyclopentadiene-based resin was measured for a glass transition temperature (Tg) via a dynamic mechanical analyzer (DMA). When the Tg is greater, the modified dicyclopentadiene-based resin has good resistance to phase changes, that is, good heat resistance.
Heating rate: 10° C./min
Temperature range: 30° C. to 300° C. (heating, cooling, heating)
   i. Peel Strength

The prepared modified dicyclopentadiene-based resin was coated on a substrate, and baked at a temperature of 120° C. for 2 minutes to form a resin film. Then, copper foils were laminated on an upper surface and a lower surface of the resin film, and hot pressed at a temperature of 210° C. for 3 hours to form a film with thickness of 200 μm. Next, the film was measured for a peel strength via a universal tensile machine. When the peel strength is greater, the modified dicyclopentadiene-based resin has good resistance to peeling from the substrate, that is, good peel resistance.

### <Evaluation Results>

It may be seen from Table 1 that when the preparation method of a modified dicyclopentadiene-based resin includes performing nitration reaction and hydrogenation reaction of a dicyclopentadiene phenolic resin in sequence to form a modified dicyclopentadiene-based resin for which the structure has at least two amino groups, and the hydrogenation reaction is performed in a solvent at a temperature of 50° C. to 120° C. (Examples 1˜3), the prepared modified dicyclopentadiene-based resin has uniform molecular weight distribution, good dielectric properties, heat resistance and peel resistance at the same time.

In addition, compared to the modified dicyclopentadiene-based resin prepared by using a mixed solvent of toluene and isopropanol as a solvent in the hydrogenation reaction (Example 1), the modified dicyclopentadiene-based resins prepared by using a solvent including dimethylacetamide (DMAC) in the hydrogenation reaction (Examples 2˜3) have greater hydrogenation rate, smaller polydispersity index, smaller dielectric constant, smaller dissipation factor, greater glass transition temperature and greater peel strength, that is, more uniform molecular weight distribution and better dielectric properties, heat resistance and peel resistance.

In addition, compared to the modified dicyclopentadiene-based resin prepared by using a mixed solvent as a solvent in the hydrogenation reaction (Examples 1˜2), the modified dicyclopentadiene-based resin prepared by using a single solvent (e.g. dimethylacetamide) as a solvent in the hydrogenation reaction (Example 3) has greater hydrogenation rate, smaller polydispersity index, smaller dielectric constant, smaller dissipation factor, greater glass transition temperature and greater peel strength, that is, more uniform molecular weight distribution and better dielectric properties, heat resistance and peel resistance.

In addition, compared to the modified dicyclopentadiene-based resin prepared by hydrogenation reaction at a temperature greater than 90° C. and a pressure less than 15 bar (Example 1), the modified dicyclopentadiene-based resins prepared by hydrogenation reaction at a temperature greater of 50° C. to 90° C. and a pressure of 15 bar to 50 bar (Examples 2˜3) have greater hydrogenation rate, smaller polydispersity index, smaller dielectric constant, smaller dissipation factor, greater glass transition temperature and greater peel strength, that is, more uniform molecular weight distribution and better dielectric properties, heat resistance and peel resistance.

Based on the above, the preparation method of a modified dicyclopentadiene-based resin of the invention forms a modified dicyclopentadiene-based resin for which the structure has at least two amino groups, so it has good molecular weight distribution uniformity, heat resistance, peel resistance and dielectric properties, and thus, it is suitable as a hardener or for forming a dicyclopentadiene-based resin with other reactive groups. Therefore, the modified dicyclopentadiene-based resin and a preparation method thereof have good applicability.

Although the invention has been disclosed in the embodiments above, they are not intended to limit the invention. Anyone with ordinary knowledge in the relevant technical field can make changes and modifications without departing from the spirit and scope of the invention. The scope of protection of the invention shall be subject to those defined by the claims attached.

What is claimed is:

1. A preparation method of a modified dicyclopentadiene-based resin, comprising:
performing nitration reaction and hydrogenation reaction of a dicyclopentadiene phenolic resin in sequence to form a modified dicyclopentadiene-based resin for which a structure has at least two amino groups,
wherein the hydrogenation reaction is performed in a solvent at a temperature of 50° C. to 120° C.

2. The preparation method of a modified dicyclopentadiene-based resin according to claim 1, wherein the solvent comprises tetrahydrofuran, toluene, isopropanol, dimethylacetamide, or a combination thereof.

3. The preparation method of a modified dicyclopentadiene-based resin according to claim 1, wherein the hydrogenation reaction is performed at a pressure of 5 bar to 100 bar for 4 hours to 12 hours.

4. The preparation method of a modified dicyclopentadiene-based resin according to claim 1, further comprising: adding a catalyst to perform the hydrogenation reaction, wherein based on a total usage amount of 100 parts by weight of a reactant, a usage amount of the catalyst is 0.5 parts by weight to 2 parts by weight.

5. A modified dicyclopentadiene-based resin, prepared by the preparation method of a modified dicyclopentadiene-based resin according to claim 1.

6. The modified dicyclopentadiene-based resin according to claim 5, a weight average molecular weight thereof is 800 to 4,000, and a number average molecular weight thereof is 400 to 2,000.

7. The modified dicyclopentadiene-based resin according to claim 5, a polydispersity index thereof is 1.2 to 2.

8. A modified dicyclopentadiene-based resin, having a structure represented by Formula (1) as follows: 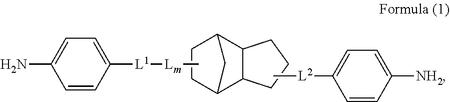
in Formula (1), L represents a dicyclopentadienylene group, a divalent organic group derived from a phenol-based compound or a combination thereof,
L¹ and L² each represent a divalent organic group derived from a phenol-based compound, and
m represents an integer from 0 to 10.

9. The modified dicyclopentadiene-based resin according to claim 8, wherein the phenol-based compound comprises phenol.

10. The modified dicyclopentadiene-based resin according to claim 8, wherein L represents 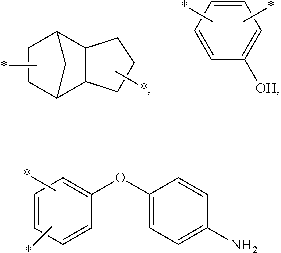
or a combination thereof, and * represents a bonding position.

11. The modified dicyclopentadiene-based resin according to claim 8, wherein L¹ and L² each represent 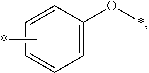
and * represents a bonding position.

12. The modified dicyclopentadiene-based resin according to claim 8, a weight average molecular weight thereof is 800 to 4,000, and a number average molecular weight thereof is 400 to 2,000.

13. The modified dicyclopentadiene-based resin according to claim 8, a polydispersity index thereof is 1.2 to 2.
